(19) United States
(12) Patent Application Publication
(10) Pub. No.: US 2024/0020626 A1
(43) Pub. Date: Jan. 18, 2024

(54) AUGMENTED REALITY SYSTEM FOR SUPPLY CHAIN OPERATIONAL ENVIRONMENTS

(71) Applicant: ThirdEye Gen, Inc, Princeton, NJ (US)

(72) Inventor: Nick Cherukuri, Princeton, NJ (US)

(21) Appl. No.: 17/864,547

(22) Filed: Jul. 14, 2022

(51) Int. Cl. G06Q 10/08; G06T 19/00

(52) U.S. Cl. CPC G06Q 10/087; G06T 19/006; G16Y 20/10

(57) ABSTRACT

An augmented reality (AR) system may be provided. The AR system may include multiple Internet of Things (IoT) tags, each IoT tag being coupled to an inventory item, each inventory item located in a supply chain operating environment. The AR system may include at least one remote processor, and an AR headset configured to communicate with the IoT tags and the remote processor(s). The AR headset may be configured to receive a first transmission of first information from at least one IoT tag, transmit a second transmission comprising the first information to the remote processor(s), receive a third transmission comprising second information from the remote processor(s), display at least a portion of the second information on a display coupled to a frame of the AR headset, and transmit fourth information comprising video or images of a field of view of the AR headset to the at least one remote processor.

### TECHNICAL FIELD

The present disclosure is drawn to the field of augmented reality systems, and specifically, augmented reality systems used in supply chain operational environments, such as warehouses.

### BACKGROUND

Internet of Things (IoT) tags are well-known in the art for tracking inventory. For example, U.S. Pat. No. 10,169,626 (the entirety of which is incorporated herein in its entirety) discloses a system and method for electronic shelf tags. Other examples include, e.g., U.S. Pat. No. 11,342,924 (the entirety of which is incorporated herein in its entirety), which discloses battery-free IoT tags and systems of use.

However, such systems rely on low-energy, relatively low-bandwidth communications. In many supply-chain situations, however, especially when collaborative work is used in conjunction with augmented reality (AR) systems are, high-bandwidth communications are required and how user interfaces are configured are important to avoid safety and/or health issues.

### BRIEF SUMMARY

To collaboratively work in a supply chain environment, an augmented reality (AR) system may be provided. The system may include a plurality of Internet of Things (IoT) tags, each IoT tag being coupled to an inventory item, each inventory item located in a supply chain operating environment. The system may include at least one remote processor. The system may include an AR headset configured to communicate with the IoT tags and the at least one remote processor.

The AR headset may be configured to receive a first transmission (such as a Bluetooth or Bluetooth low energy transmission) comprising first information (which may include, e.g., one or more encrypted packets) from at least one of the plurality of IoT tags, and transmit a second transmission comprising the first information to the at least one remote processor.

The AR headset may be configured to receive a third transmission that includes second information from the at least one remote processor and display at least a portion of the second information on a display coupled to a frame of the AR headset. In some embodiments, the third transmission may be received in response to a request sent from the AR headset after one of the IoT tags is scanned (which may include scanning a two- or three-dimensional barcode).

In some embodiments, the second information may include data pulled from a transfer table, as well as data relating to at least one IoT tag event.

The AR headset may be configured to transmit fourth information comprising video or images of a field of view of the AR headset to the at least one remote processor. In some embodiments, the video or images may be displayed on a display operably coupled to the at least one remote processor or the video or images may be transmitted to a remote device and displayed on the remote device.

In some embodiments, the AR headset may be configured to receive visual and/or audible instructions from the remote processor and/or remote device, and then play any visual and/or audible instructions using the display coupled to the frame of the AR headset and/or speakers coupled to the frame of the AR headset as appropriate.

In some embodiments, the AR headset may be configured to display at least some visual instructions relative to real-life coordinates. In some embodiments, the AR headset may be configured to display at least some visual instructions to a predetermined, fixed location on the display coupled to the frame of the AR headset. In some embodiments, the AR headset may be configured to display at least some visual instructions on a true field of view (FOV) of the AR headset, as opposed to placing the instructions relative to a camera feed (e.g., input of a camera coupled to the frame of the AR headset) of the user's vision, which may be overlaid on the user's true vision.

In some embodiments, the AR headset may be configured to display one or more graphical user interfaces for engaging in remote collaborations.

In some embodiments, the AR headset may be configured to identify an inventory item coupled to an IoT tag that was scanned. In some embodiments, the AR headset may be configured to highlight the identified inventory item via a visual overlay on the display coupled to the frame of the AR headset. In some embodiments, the AR headset may be configured to display floating SKU-data above the inventory item on the display coupled to the frame of the AR headset.

In some embodiments, the system may include a real-time locating system (RTLS) configured to determine a location of each of the plurality of IoT tags. In some embodiments, the AR headset may be configured to request and receive coordinates of a scanned IoT tag from the RTLS, and display the second information in a location based on the coordinates of the scanned IoT tag.

### BRIEF DESCRIPTION OF DRAWINGS

FIGS. 1 and 2 are illustrations of a system.

FIG. 3 is an illustration of a display shown to a user while using an AR headset in a supply chain environment.

FIG. 4A is a block diagram of various components and their connections of an AR headset.

FIG. 4B is an illustration of a front perspective view of an AR headset.

FIG. 5A is a flowchart of a method.

FIG. 5B is a flowchart of a determination step of the method of FIG. 5A.

### DETAILED DESCRIPTION

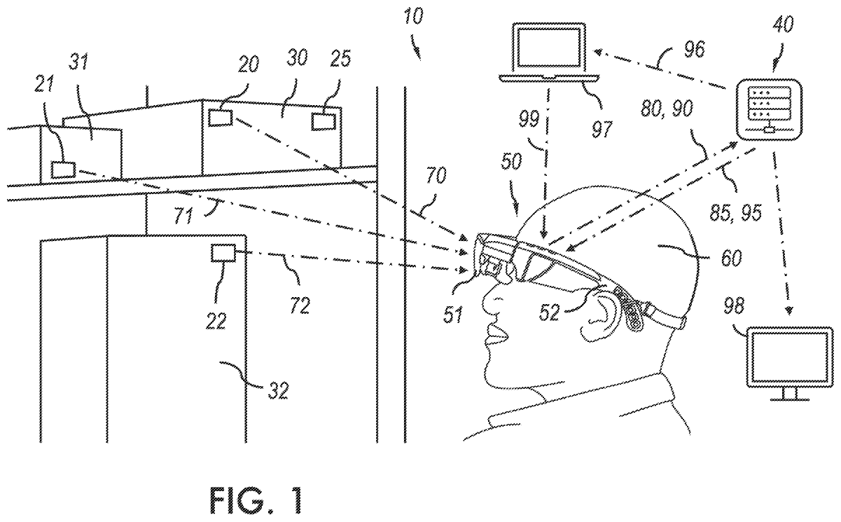

To improve tracking in warehouses, in some embodiments, an augmented reality (AR) system may be provided. Referring to FIG. 1, in some embodiments, a system 10 may include a plurality of Internet of Things (IoT) tags 20, 21, 22. Each IoT tag may be coupled to an inventory item 30, 31, 32. Each inventory item may be in a supply chain operating environment (e.g., warehouses, shipping yards, cargo containers, manufacturing floors, etc.)

Further, the system 10 may include at least one remote processor 40. The remote processor may be, e.g., one or more processors on a remote server. As used herein, the term “processor” is not limited merely to those integrated circuits referred to in the art as a processor, but broadly refers to a microcontroller, a microcomputer, a programmable logic controller, an application-specific integrated circuit, and any other programmable circuit. Each processor will typically be operably coupled to a memory and a non-transitory computer-readable storage medium containing instructions for configuring the processor.

Further, the system 10 may include an AR headset 50. The AR headset may include a display 51 and speakers 52 coupled to the headset, which are configured to allow visual and audio information, respectively, to be provided to a user 60.

The AR headset may be configured to receive a first transmission 70, 71, 72 comprising first information from at least one of the plurality of IoT tags 20, 21, 22. In some embodiments, the first transmission is a Bluetooth low energy transmission. In some embodiments, the first information includes at least one encrypted packet.

The AR headset may be configured to transmit a second transmission 80 comprising the first information to the at least one remote processor 40. That is, in some embodiments, the AR headset may be configured to function as a unidirectional gateway such that IoT tags that cannot communicate through a traditional hub can transmit data to a server via the AR headset. In some embodiments, the AR headset may receive the Bluetooth low energy transmissions and may convert the entire received transmission into a different protocol (e.g., for transmitting via 5G, or over a long range (LoRa) radio. In some embodiments, the headset may only transmit the payload from the received transmission. In some embodiments, each encrypted packet is transmitted.

The AR headset may be configured to receive a third transmission 85 comprising second information from the at least one remote processor.

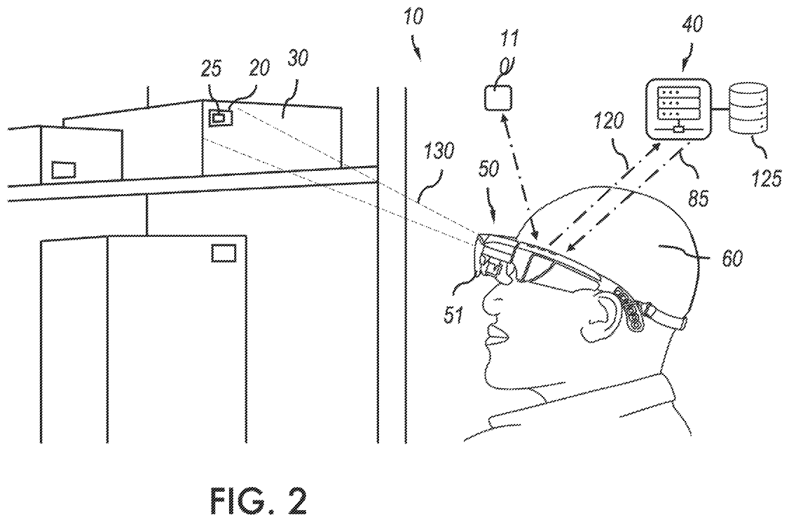

Referring to FIG. 2, in some embodiments, the third transmission 85 is received in response to a request 120 sent from the AR headset after one of the IoT tags is scanned 130.

In some embodiments, scanning an IoT tag 20 includes scanning a two- or three-dimensional barcode 25 (such as a QR code). In some embodiments, the barcode may be on an external surface of the IoT tag.

In some embodiments, the second information may be information related to the scanned tag. In some embodiments, the second information may include data pulled from a transfer table (e.g., which may be on a database 125 operably coupled to a remote processor), as well as data relating to at least one IoT tag event (e.g., which may be stored on a database, such as database 125).

In some embodiments, the data pulled from the transfer table may be data representative of a warehouse management system (WMS) or enterprise resource planning (ERP) system, such as an item name, an item description, an item number, a serial number, etc.).

In some embodiments, the IoT tag event may include an environmental condition (temperature, humidity, etc.).

After receiving the second information, the AR headset may be configured to display at least a portion of the second information on a display 51 coupled to a frame of the AR headset 50.

To facilitate collaboration, referring to FIG. 1, the AR headset may be configured to send a transmission 90 of fourth information comprising video or images of a field of view of the AR headset to the at least one remote processor.

In some embodiments, the video or images transmitted to the at least one remote processor may then be displayed on a display 98 operably coupled to the at least one remote processor and/or transmitted 96 to a remote device 97 and displayed on the remote device.

In some embodiments, the AR headset may be configured to receive one or more transmission 95, 99 that include visual and/or audible instructions from the remote processor 40 and/or remote device 97 and play any visual and/or audible instructions using the display 51 coupled to the frame of the AR headset and/or speakers 52 coupled to the frame of the AR headset.

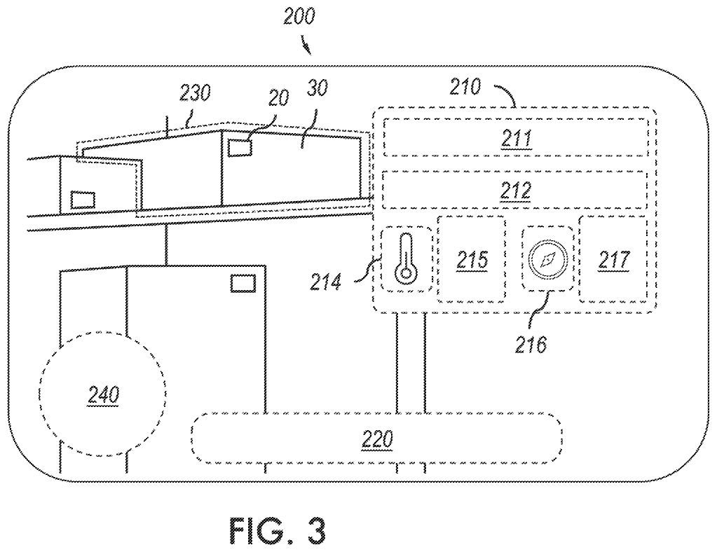

Referring to FIG. 3, in some embodiments, a graphical user interface (GUI) 200 of the AR headset may include one or more overlays 210, 220, 230, 240.

In some embodiments, the GUI may include a first type of overlay 210. The first type of overlay may display some or all of the second information. The first type of overlay may include text or images relating to a scanned IoT tag 20 and/or inventory item 30 associated with the scanned tag. For example, in some embodiments, the first type of overlay may include one or more first portions 211 that displays an item name, tag ID number, and/or a sku or part number. The first type of overlay may include one or more second portions 212 that display other relevant information about the tag and/or inventory item, such as quantity, manufacturer, lot number, expiration date, verbose descriptions of the item, etc. In some embodiments, second portion 212 may include instructions for the user. In some embodiments, second portion 212 may be free of instructions. The first overlay may include one or more third portions 214, 216 that may include icons or images representative of a tag event or a location, and one or more fourth portions 215, 217 adjacent to the third portions containing information relating to the tag event or location. As seen in FIG. 3, third portion 214 shows a thermometer icon, while fourth portion 215 may include the most recent temperature event sent by scanned tag 20. In FIG. 3, third portion 216 shows a compass icon, indicating location information, while fourth portion 217 may include location data. In some embodiments, the location data may include a zone number, rack number, and/or bin number. In some embodiments, the location data may include an absolute three-dimensional position (e.g., a GPS position). In some embodiments, the location may include relative three-dimensional position (e.g., the 3D position of the tag within the warehouse or other supply chain environment.

Referring to FIG. 2, in some embodiments, the AR system may include a real-time locating system (RTLS) 110. The RTLS may be configured to determine a location of each of the plurality of IoT tags. Such systems are well-known in the art, and generally involve the use of multiple antennas to triangulate the position of a tag. One example of such a system can be seen with reference to U.S. Pat. No. 10,942,251, the entirety of which is incorporated by reference herein.

In some embodiments, the AR headset may be configured to request and receive coordinates of a scanned IoT tag from the RTLS.

Referring to FIG. 3, in some embodiments, the second information may be displayed in a location based on the coordinates of the scanned IoT tag. For example, in some embodiments, the first overlay may be configured to be displayed as if it was positioned adjacent to the scanned tag and/or the inventory item associated with the scanned tag. In such an embodiment, if a user of the headset turns around to face directly away from the scanned tag, the second information would no longer be visible. When the user's field of view does not include the position of the first overlay, the first overlay would not be displayed. In other embodiments, the first overlay may be configured to be always displayed in a fixed location in the field of view until a user closes the overlay.

In some embodiments, the AR headset may be configured to display floating SKU-data above the inventory item.

As noted previously, in some embodiments, the first type of overlay 210 may include a second portion 212 containing instructions. In some embodiments, the instructions are positioned separately from the first type of overlay. In some embodiments, a second type of overlay 220 may by utilized, the second type configured to include instructions.

The instructions may be steps the user may need or wish to undertake (e.g., “use a forklift to move this item”), warnings for the user to consider or be aware of (e.g., “item must be kept below 25° C.” or “the item may shift within the box when moving”), or annotations for the user (e.g., “a ladder for reaching this item is located at the end of the rack” or “the box was previously opened”). In some embodiments, the instructions may be from a person collaborating with the user of the AR headset. In some embodiments, the instructions may be acquired from a database. In some embodiments, the instructions may be based on the type of inventor item (e.g., all items of a certain type would display certain instructions). In some embodiments, the instructions may be from a user who interacted with the tag or inventory item previously.

In some embodiments, the second overlay may be configured to display at least some visual instructions relative to real-life coordinates. Like the above-described first overlay, in such an embodiment, if a user turns around to face directly away from the real-life coordinates, the second overlay would no longer be visible. In other embodiments, the second overlay may be configured to be always displayed in a fixed, predetermined location in the field of view until a user closes the overlay.

In some embodiments, the instructions may be displayed relative to a camera feed of the AR headset, overlaid onto the user's vision. In some embodiments, the instructions may be displayed on a true field of view (FOV) of the AR headset.

In some embodiments, a third type of overlay 230 may be utilized, the third type configured to highlight objects in the field of view. In some embodiments, the AR headset may be configured to identify the inventory item coupled to the IoT tag that was scanned. For example, in some embodiments, the AR headset may be configured to capture at least one image from a camera coupled to the AR headset, identify an IoT tag (e.g., via a two- or three-dimensional bar code), identify edges defining an outline of the item the identified IoT tag is attached to (in FIG. 3, inventory item 30), and then provide a graphical display 230 that is based on the outline, the graphical display being a visual overlay that highlights the inventory item for the user.

In some embodiments, the graphical display matches the outline of the item. In some embodiments, the graphical display substantially matches the outline, but is a few pixels (e.g., 10 or less) larger in each direction. In some embodiments, the graphical display is a box around the item (that does not include additional items).

In some embodiments, a fourth type of overlay 240 may be utilized. The fourth type of overlay may include, e.g., a video chat session. The overlay may include an image or video of a person to whom the user of the AR headset is communicating with (e.g., a user of remote device 97).

The fourth type of overlay may be provided when a video chat session is requested by the user of the headset and/or a remote user.

The fourth type of overlay may alternatively include a video or image indicating what should be done with the inventory item, where the inventory item should be delivered, or who needs to be contacted with any questions about the item. For example, in some embodiments, a safety officer may be the point of contact for certain items (such as items that are explosive, flammable, etc.).

One or more GUIs and/or one or more of the first, second, third, or fourth type of overlays may be used for engaging in remote collaborations.

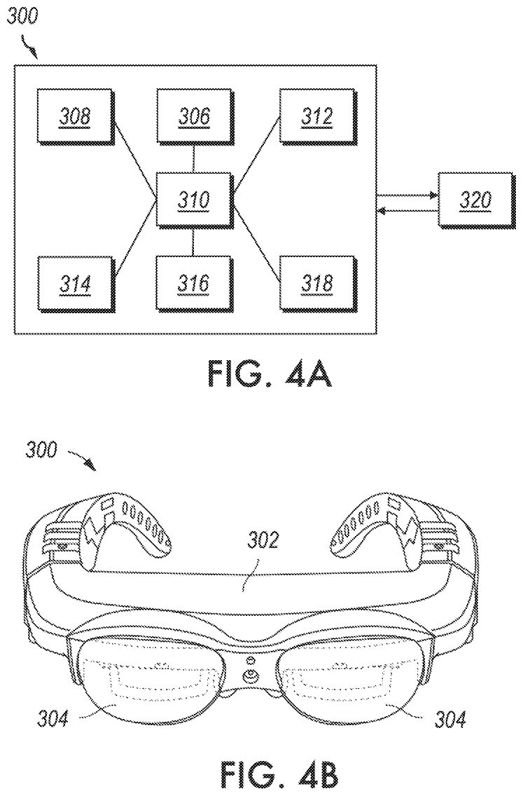

A non-limiting example of an AR headset can be seen with reference to FIGS. 4A and 4B.

Referring to FIGS. 4A and 4B, the AR headset 300 may include a frame 302 supporting a glasses lens/optical display 304, which is configured to be worn by the user. The frame 302 is associated with a processor. In some embodiments, AR headset or AR glasses may include a processor 310, such as a qualcomm xrl processor which contains 4 GB RAM, 64 GB storage, an integrated cpu/gpu and an additional memory option via usb-c port. The processor may be located on, e.g., the left-hand side arm enclosing of the frame and shielded with protective material to dissipate the processor heat. Generally, the processor 310 may be configured to synchronize data (such as the IMU data) with camera feed data, to provide a seamless display of 3D content of the augmented reality application 320. The optical display 304 may be coupled to the processor 310 and a camera PCB board. In some embodiments, an IMU, GPS, or other position and/or orientation-sensing device may be present in or on any portion of the frame. For example, in some embodiments, the IMU is positioned above the display 304.

A sensor assembly 306 may be in communication with the processor 310.

A camera assembly 308 may be in communication with the processor and may include, e.g., a 13-megapixel RGB camera, 2 wide angle grey scale cameras, a flashlight, an ambient light sensor (ALS) and a thermal sensor. All these camera sensors may be located on the front face of the headset or glasses and may be angled, e.g., 5 degrees below horizontal to closely match the natural human field of view.

A user interface control assembly 312 may be in communication with the processor 310. The user interface control assembly may include, e.g., audio command control, head motion control and a wireless Bluetooth controller which may be coupled to, e.g., an android wireless keypad controlled via a built-in Bluetooth BT 5.0 LE system in the xrl processor. The head motion control may utilize a built-in android IMU sensor to track the user's head movement via three degrees of freedom, i.e., if a user moves their head to the left the cursor moves to the left as well. The audio commands may be controlled by, e.g., a three-microphone system located in the front of the glasses that captures audio commands in English. These different modes of UI allow the user to pick and choose their personal preference for UI.

In some embodiments, the single device may include a radio in communication with the processor 210, the radio having a range of 3-10 miles line-of-sight, and a bandwidth less than 30 kbits/sec. In some embodiments, the radio is a Long Range (LoRa) radio. In some embodiments, the radio is configured for 5G transmissions.

A fan assembly 314 may be in communication with the processor 310, wherein the fan assembly 314 is synchronized to speed up or slow down based on the processor's heat.

A speaker system or speaker 316 may be in communication with the processor 310. The speaker system or speaker may be configured to deliver audio data to the user via the communication unit.

A connector port assembly 318 may be in communication with the processor. The connector port assembly may have, e.g., a mini-jack port and a Universal Serial Bus Type-C (USB-C) port. The connector port assembly 318 allows users to insert their manual audio headphones. The USB-C port allows the user to charge the device or data-transfer purposes. In one embodiment, the frame 302 is further integrated with a wireless transceiver coupled to the processor 310.

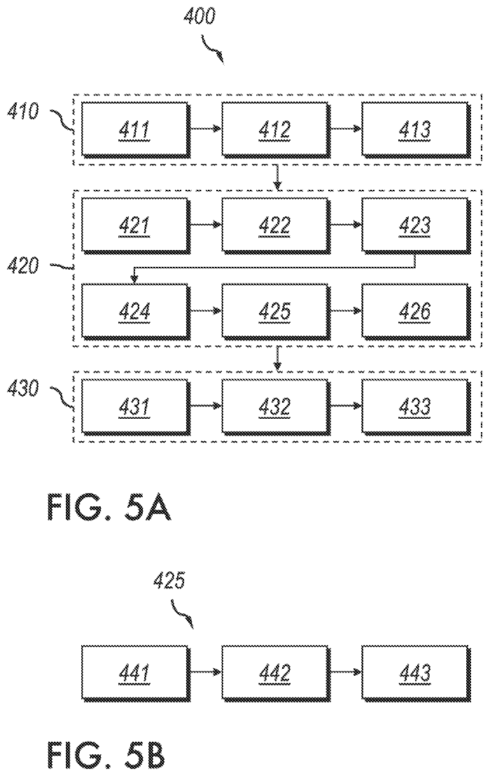

In some embodiments, a method for improved communication in a supply chain environment may be provided. Referring to FIG. 5A, the method 400 may include receive a first set 410 of steps related to conveying first information. The first set of steps may include receiving 411 a first transmission comprising first information from at least one of the plurality of IoT tags. The method may include converting 412 the first transmission from a first protocol to a second protocol. The first protocol may be a Bluetooth or Bluetooth low energy protocol. The second protocol may be TCP/IP. The first information may include at least one encrypted packet. The method may include transmitting 413 a second transmission comprising the first information to at least one remote processor, using the second protocol.

The method 400 may include a second set 420 of steps related to conveying second information. The second set of steps may be performed at any time relative to other sets of steps.

In some embodiments, the second set of steps may include scanning 421 an IoT tag (which may include capturing at least one image and decoding a portion of the at least one image containing a two- or three-dimensional barcode).

In some embodiments, the second set of steps may include sending 422 a request from the AR headset to the remote processor(s), the request including information related to the scanned IoT tag, such as the decoded two- or three-dimensional barcode.

In some embodiments, the second set of steps may include retrieving 423 data from a transfer table and retrieving data relating to at least one IoT tag event, based on the information in the request related to the scanned IoT tag. This may include gathering information from different databases operably connected to the remote processor(s). In some embodiments, the gathered information may include item name, tag ID number, a sku or part number, quantity, manufacturer, lot number, expiration date, verbose descriptions of the item, NFPA safety ratings (or similar), zone/rack/bin numbers, temperatures, pressures, etc.

In some embodiments, the second set of steps may include receiving 424 a third transmission from the remote processor(s). In some embodiments, the third transmission is received in response to the request sent from the AR headset after one of the IoT tags is scanned. The third transmission may include second information from the remote processor(s), the second information including the information gathered from various databases as described herein (e.g., item name, tag ID number, sku/part number, etc.).

In some embodiments, the second set of steps may include determining 425 a location for displaying at least some of the second information.

In some embodiments, the location may be generally predetermined. That is, in some embodiments, some of the second information may be configured to be displayed in a container of fixed dimensions that is offset Xpixels to the right of the upper-left most pixel of the display, and Y pixels down from the upper-left most pixel of the display, where Xis a number between 0 and the total number of columns of pixels in the display, and Yis a number between 0 and the total number of rows of pixels in then display). The exact location of any text to be displayed can then be determined, e.g., based on the length of the text, etc.

Referring to FIG. 5B, in some embodiments, determining 425 a location for displaying the information may include multiple steps.

In some embodiments, the steps may include identifying 441 edges of an object to which the scanned IoT tag is attached, using a captured image (such as the image captured when scanning an IoT tag). In some embodiments, this is done in near-real time, where the AR headset captures video, extracts certain frames, checks the frame to determine whether a scanned two- or three-dimensional barcode is present, then identifies edges using known edge-detection techniques.

The steps may include identifying 442 an intermediate point, the intermediate point being a top-most, right-most, bottom-most, and/or left-most point of the object in the image (based on the identified edges).

The steps may include identifying 443 a closest location, the closest location being offset from the intermediate point by some predetermined amount, such that the closest available location is separated from every identified edge by at least the offset amount. In some embodiments, the offset is a number of pixels in the X and Y directions.

As a simple example, the object the IoT tag is attached to appears as a square box with corners at pixels (0,0), (10, 0), (10,10), and (0, 10) in the display. If the AR headset is configured to display certain text to the top-right of the object, the intermediate point might be the top-right corner (e.g., (10,0)) and the predetermined offset is, e.g., (5, 0) pixels, the closest location could be (15, 0), since the right-most point of 10+5 pixel offset=15 and the top-most point of 0+0 pixel offset).

In some embodiments, a location of any text to be displayed may then be based on the determined closest location.

In some embodiments, determining the location may include requesting and receiving coordinates of a scanned IoT tag from a RTLS, and determining the location based on the coordinates. For example, in some embodiments, the location is a location in space based on the coordinates of the IoT tag, then incorporating X, Y, and/or Z offsets (if using a cartesian coordinate system). For example, in some embodiments, the SKU of an item may appear to float a fixed distance above the IoT tag in the display when the field of view of the headset is oriented to capture both the tag and the text.

In some embodiments, the AR headset may be configured to determine a location using real-life coordinates. For example, if an IoT tag is in a warehouse in location (10,10,1) using (X, Y, Z) coordinates based on position within a warehouse, the location for text to be displayed may be (10,10,1.5) if the text is intended to be positioned above the IoT tag. In this simple example, the headset would not display the text unless the headset is oriented such that the field of view includes position 10, 10, 1.5. The displayed text will move in the user's field of view as the user moves around and rotates the headset, for example.

In some embodiments, the AR headset may be configured to determine a location based on a position on the display. The displayed text will have a static position in the user's field of view as the user moves around and rotates the headset, for example.

In some embodiments, the AR headset may be configured to determine a location using a true field of view of the AR headset, as opposed to the field of view of a camera coupled to the frame of the headset.

Referring to FIG. 5A, in some embodiments, the second set of steps may include displaying 426 at least a portion of the second information on a display coupled to a frame of the AR headset, at the determined location (from the step of determining 425). Using this simple example, the AR headset may, e.g., display a first type of overlay 210 as disclosed herein, where the upper-left corner of the displayed overlay is the closest location (e.g., (15, 0)), where the first type of overlay includes some or all of the second information.

The method 400 may include a third set 430 of steps related to collaborative information sharing. The third set of steps may be performed at any time relative to other sets of steps.

In some embodiments, the third set of steps may include transmitting 431 fourth information comprising video or images of a field of view of the AR headset (e.g., captured from a camera coupled to the frame of the AR headset) to the at least one remote processor. In some embodiments, the fourth information includes both visual and audio content. In some embodiments, only visual content is transmitted.

In some embodiments, the third set of steps may include displaying 432 the video or images on a display, the display either being coupled to the at least one remote processor, or a part of a remote device (such as a mobile phone, tablet, laptop computer, or desktop computer).

In some embodiments, the third set of steps may include receiving 433 instructions to be provided to the user of the headset, either visually or audibly. In some embodiments, the instructions may include an annotated image (e.g., generated by a remote user and transmitted from the at least one remote processor and/or remote device). In some embodiments, the instructions may include text instructions to be visually displayed. In some embodiments, the instructions may include a request for a video call with the remote user.

In some embodiments, the method may include providing any visual and/or audible instructions to the user of the AR headset using the display coupled to the frame of the AR headset and/or speakers coupled to the frame of the AR headset.

While the invention is described through the above-described exemplary embodiments, modifications to, and variations of, the illustrated embodiments may be made without departing from the inventive concepts disclosed herein. For example, although specific parameter values, such as dimensions and materials, may be recited in relation to disclosed embodiments, within the scope of the invention, the values of all parameters may vary over wide ranges to suit different applications.

As used herein, including in the claims, the term “and/or,” used in connection with a list of items, means one or more of the items in the list, i.e., at least one of the items in the list, but not necessarily all the items in the list.

Disclosed aspects, or portions thereof, may be combined in ways not listed above and/or not explicitly claimed. In addition, embodiments disclosed herein may be suitably practiced, absent any element that is not specifically disclosed herein. Accordingly, the invention should not be viewed as being limited to the disclosed embodiments.

What is claimed is:

1. An augmented reality (AR) system, comprising:
a plurality of Internet of Things (IoT) tags, each IoT tag being coupled to an inventory item, each inventory item located in a supply chain operating environment;
at least one remote processor; and
an AR headset configured to:
receive a first transmission comprising first information from at least one of the plurality of IoT tags, and transmit a second transmission comprising the first information to the at least one remote processor;
receive a third transmission comprising second information from the at least one remote processor, and display at least a portion of the second information on a display coupled to a frame of the AR headset; and
transmit fourth information comprising video or images of a field of view of the AR headset to the at least one remote processor.

2. The AR system according to claim 1, wherein the video or images are displayed on a display operably coupled to the at least one remote processor, or are transmitted to a remote device and displayed on the remote device.

3. The AR system according to claim 2, wherein the AR headset is configured to receive visual and/or audible instructions from the remote processor and/or remote device and play any visual and/or audible instructions using the display coupled to the frame of the AR headset and/or speakers coupled to the frame of the AR headset.

4. The AR system according to claim 3, wherein the AR headset is configured to display at least some visual instructions relative to real-life coordinates.

5. The AR system according to claim 3, wherein the AR headset is configured to display at least some visual instructions to a predetermined location on the display coupled to the frame of the AR headset.

6. The AR system according to claim 3, wherein the AR headset is configured to display at least some visual instructions on a true field of view (FOV) of the AR headset.

7. The AR system according to claim 3, wherein the AR headset is configured to display one or more graphical user interfaces for engaging in remote collaborations.

8. The AR system according to claim 1, wherein the first transmission is a Bluetooth transmission, and the first information includes at least one encrypted packet.

9. The AR system according to claim 1, wherein the third transmission is received in response to a request sent from the AR headset after one of the IoT tags is scanned.

10. The AR system according to claim 9, wherein scanning an IoT tag includes scanning a two- or three-dimensional barcode.

11. The AR system according to claim 10, wherein the second information includes data pulled from a transfer table, as well as data relating to at least one IoT tag event.

12. The AR system according to claim 11, wherein the AR headset is configured to identify the inventory item coupled to the IoT tag that was scanned.

13. The AR system according to claim 12, wherein the AR headset is configured to highlight the inventory item via a visual overlay on the display coupled to the frame of the AR headset.

14. The AR system according to claim 13, wherein the AR headset is configured to display floating SKU-data above the inventory item on the display coupled to the frame of the AR headset.

15. The AR system according to claim 14, further comprising a real-time locating system (RTLS) configured to determine a location of each of the plurality of IoT tags.

16. The AR system according to claim 15, wherein the AR headset is configured to request and receive coordinates of a scanned IoT tag from the RTLS, and display the second information in a location based on the coordinates of the scanned IoT tag.
